(19) United States
(12) Patent Application Publication
(10) Pub. No.: US 2010/0042492 A1
(43) Pub. Date: Feb. 18, 2010

(54) METHODS AND APPARATUS FOR DETERMINING ADVERTISEMENT RELEVANCE

(75) Inventor: Richard Stokes, Chicago, IL (US)

Correspondence Address: K&L Gates LLP, P.O. Box 1135, CHICAGO, IL, 60690, US

(73) Assignee: ADGOOROO, LLC, Chicago, IL (US)

(21) Appl. No.: 12/509,734

(22) Filed: Jul. 27, 2009

Related U.S. Application Data
(60) Provisional application No. 61/089,113, filed on Aug. 15, 2008.

(51) Int. Cl. G06Q 30/00

(52) U.S. Cl. 705/14.43; 705/14.54

(57) ABSTRACT

The present disclosure provides a system that filters out underperforming ads from a historical database of ads and leaves the most effective ads by applying three separate filters. The first filter removes ineffective ads based on coverage. Coverage is the percentage of the time that an ad appears for a given keyword. The second filter removes ads which appear below some threshold position (e.g., position five in Google), because many search engines reward ads with high clickthrough rates with a position bonus. The third filter removes ads which have not run some minimum threshold period of time (e.g., four weeks). Advertisers may then view the remaining ads (i.e., the effective ads) associated with keywords of interest and mine those ads for words to be used in their own ad copy.

### TECHNICAL FIELD

The present application relates in general to web based advertising and more specifically to methods and apparatus for determining advertisement relevance.

### BACKGROUND

Web based advertisements (ads) are often selected for display based on keywords entered by a user of a search engine (e.g., Google). More effective ads (e.g., ads with relatively high clickthrough rates) typically have a higher display priority than ineffective ads (e.g., ads with relatively low clickthrough rates). Accordingly, advertisers strive to produce effective ad copy (i.e., words that attract more clickthroughs).

An effective way to measure an ad's effectiveness is to simultaneously measure the ad's clickthrough rate against other ad's clickthrough rate, keeping average position and keyword the same. However, this is a challenging task due to a lack of publicly available clickthrough rate data.

### SUMMARY

The presently disclosed system solves this problem by relying only on data that can be automatically gathered from public sources and standardized across keyword and position. These measurements serve as a suitable proxy for clickthrough rate data. This method is then applied to a historical ad archive to determine the most effective ad copy.

The system described herein filters out underperforming ads and leaves the most effective ads. For example, a certain group of keywords may be associated with over five thousand different ads. Some of these ads are more effective than others. By applying the three separate filters described below, typically only 5% of the ads remain as good (relevant) ads. Advertisers may then view these effective ads and mine them for ideas about how to write their own ad copy.

### BRIEF DESCRIPTION OF THE FIGURES

FIG. 1 is a high level block diagram of an example communications system.

FIG. 2 is a more detailed block diagram showing one example of a computing device.

FIG. 3 is a flowchart showing one example of a process for determining advertisement relevance.

FIG. 4 is an example of effective ad copy that remains after a plurality of ads are filtered.

FIG. 5 is another example of effective ad copy that remains after a plurality of ads are filtered.

FIG. 6 is an example screen-shot of a web based report showing a determination of advertisement relevance.

### DETAILED DESCRIPTION

Advertisers can use the tool described herein to help them discover the most powerful online ad copy. Users can see what's working and what's not in any given space. The reporting tool automatically finds the best ad copy in the keywords any particular user has chosen to track. The reporting tool is designed to achieve the dual objectives of identifying the most effective ads being displayed on Google (or other search engines) and helping advertisers apply successful copywriting tactics. The reports are based on an automatically generated and updated database containing most of the world's online ad copy, and applies a methodology based on coverage, position and the duration of an ad's online lifecycle to find the most effective ads appearing in response to specific keyword searches.

Google, Yahoo, Bing and other search engines consider clickthrough rates to be a proxy for relevance. Relevance is good for everyone. Search engine users find relevant ads to be more helpful and click on them more often with real intent to buy. Advertisers with more relevant ads pay less per visitor, even while enjoying more targeted traffic. And, the search engine earns more per keyword due to the high clickthrough rates. However, because these clickthrough rates are not publicly available, the system described herein estimates clickthrough rates based on other measurements which are available.

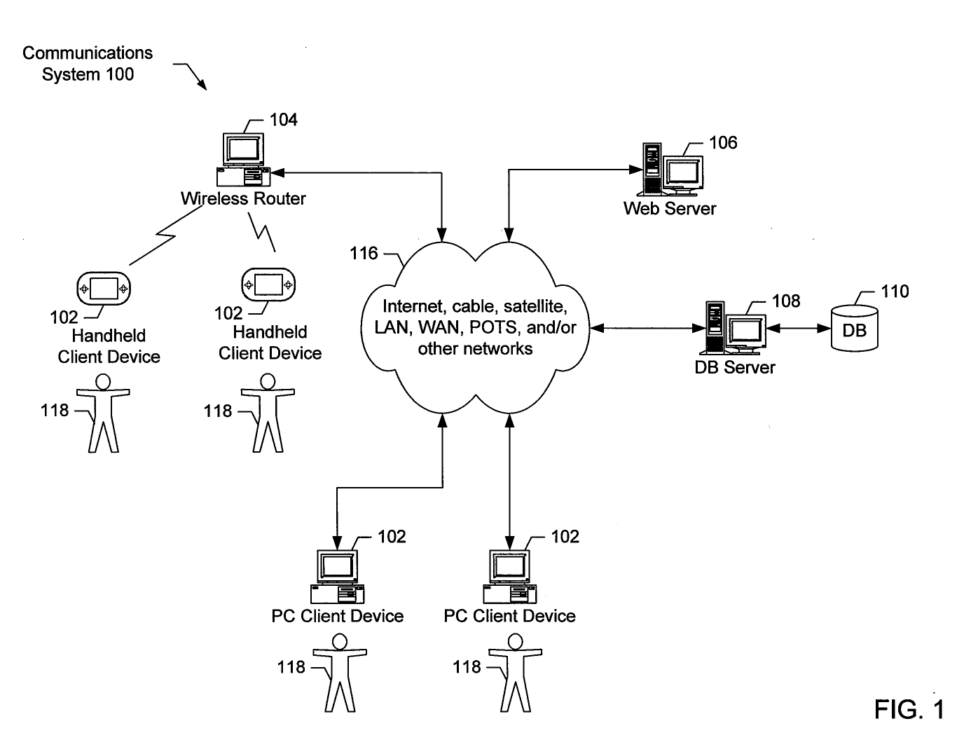

The disclosed system is most readily realized in a network communications system. A high level block diagram of an exemplary network communications system 100 is illustrated in FIG. 1. The illustrated system 100 includes one or more client devices 102, one or more wireless routers 104, one or more web servers 106, and one or more database servers 108 connected to one or more databases 110. Each of these devices may communicate with each other via a connection to one or more communications channels 116. The communications channels 116 may be any suitable communications channels 116 such as the Internet, cable, satellite, local area network, wide area networks, telephone networks, etc. It will be appreciated that any of the devices described herein may be directly connected to each other and/or connected over one or more networks.

In an example mode of operation, users 118 of the system 100 consume one or more web pages received from the web server 106. The web pages may be any suitable type of web page such as search engine results. The web pages preferably include advertising content and non-advertising content.

One web server 106 may interact with a large number of client devices 102. Accordingly, each web server 106 is typically a high end computing device with a large storage capacity, one or more fast microprocessors, and one or more high speed network connections. Conversely, relative to a typical web server 106, each client device 102 typically includes less storage capacity, less processing power, and a slower network connection.

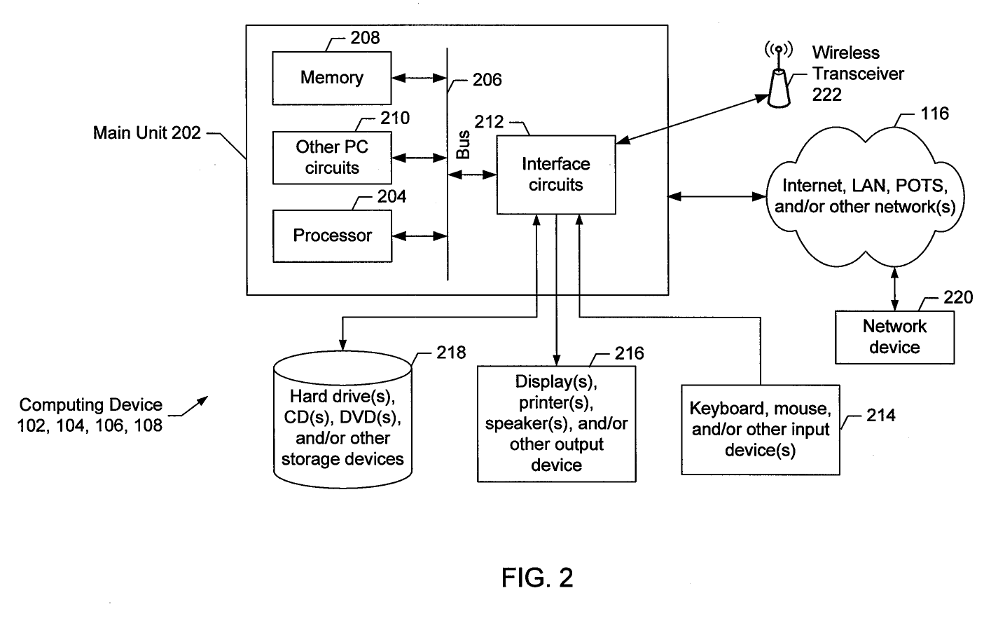

A detailed block diagram of an example computing device 102, 104, 106, 108 is illustrated in FIG. 2. Each computing device 102, 104, 106, 108 may include a server, a personal computer (PC), a personal digital assistant (PDA), a portable audio player, a portable audio/video player, a mobile telephone, and/or any other suitable computing device. Each computing device 102, 104, 106, 108 preferably includes a main unit 202 which preferably includes one or more processors 204 electrically coupled by an address/data bus 206 to one or more memory devices 208, other computer circuitry 210, and one or more interface circuits 212. The processor 204 may be any suitable microprocessor.

The memory 208 preferably includes volatile memory and non-volatile memory. Preferably, the memory 208 and/or another storage device 218 stores software instructions that interact with the other devices in the system 100 as described herein. These software instructions may be executed by the processor 204 in any suitable manner. The memory 208 and/or another storage device 218 may also store one or more data structures, digital data indicative of documents, files, programs, web pages, etc. retrieved from another computing device 102, 104, 106, 108 and/or loaded via an input device 214.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the computing device 102, 104, 106, 108. For example, the display 216 may be used to display web pages received from the web server 106. The visual displays may include prompts for human input, run time statistics, calculated values, data, etc.

One or more storage devices 218 may also be connected to the main unit 202 via the interface circuit 212. For example, a hard drive, CD drive, DVD drive, flash memory drive, and/or other storage devices may be connected to the main unit 202. The storage devices 218 may store any type of data used by the computing device 102, 104, 106, 108.

Each computing device 102, 104, 106, 108 may also exchange data with other computing devices 102, 104, 106, 108 and/or other network devices 220 via a connection to the communication channel(s) 116. The communication channel(s) 116 may be any type of network connection, such as an Ethernet connection, WiFi, WiMax, digital subscriber line (DSL), telephone line, coaxial cable, etc. Users of the system 100 may be required to register with the web server 106. In such an instance, each user may choose a user identifier (e.g., e-mail address) and a password which may be required for the activation of services. The user identifier and password may be passed across the communication channel(s) 116 using encryption built into the user's browser, software application, or device. Alternatively, the user identifier and/or password may be assigned by the web server 106.

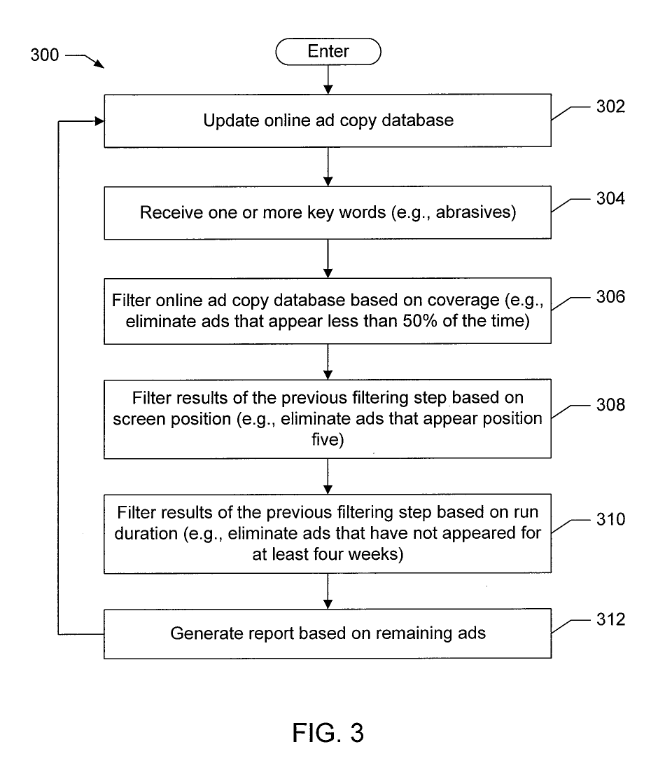

A flowchart of an example process 300 for determining advertisement relevance is presented in FIG. 3. Preferably, the process 300 is embodied in one or more software programs which is stored in one or more memories and executed by one or more processors. Although the process 300 is described with reference to the flowchart illustrated in FIG. 3, it will be appreciated that many other methods of performing the acts associated with process 300 may be used. For example, the order of many of the steps may be changed, and some of the steps described may be optional.

In general, the process 300 filters out underperforming ads from a historical database of ads and leaves the most effective ads by applying three separate filters. The first filter removes ineffective ads based on coverage. Coverage is the percentage of the time that an ad appears for a given keyword. The second filter removes ads which appear below some threshold position (e.g., position five in Google), because many search engines reward ads with high clickthrough rates with a position bonus. The third filter removes ads which have not run some minimum threshold period of time (e.g., four weeks). Advertisers may then view the remaining ads (i.e., the effective ads) associated with keywords of interest and mine those ads for words to be used in their own ad copy.

The database 110 used by the process 300 is automatically generated and continually updated to contain most of the world's online ad copy (block 302). Users 118 of the system may log in to a web server 106 from a client device 102 and enter one or more key words the user 118 may be interested in (block 304). For example, if the user 118 sells abrasives, the user 118 may enter the term “abrasives.” Alternatively, or in addition, users of the system may query the system using an application programming interface (API). For example, software designed to construct online ads may query the system in real time.

The system then filters the database of ads based on coverage (block 306). This first filter eliminates ads which appear less than some threshold percentage of the time. For example, the system may eliminate ads that appear less than 50% of the time, Search engine algorithms, such as the Google AdWords algorithm, are designed to show ads with higher clickthrough rates more frequently than ads with lower clickthrough rates. While this applies at the campaign level (i.e., by default, more effective ads will appear more frequently than less effective ones, unless this feature is turned off), it has also been shown to apply across campaigns and advertisers. If two advertisers are bidding equally on the same term, the one whose ads have the higher clickthrough rate will be shown more often.

Thus, the first filter applied by the current system to the database of ads removes ineffective ads based on coverage. Coverage is the percentage of the time that an ad appears for a given keyword. Ineffective ads will be shown less frequently, so by applying a coverage threshold to the ad database, the system removes a large percentage of the ineffective ads.

The second filter used by the present system is to eliminate ads which appear below some threshold position (block 308). For example, the system may eliminate ads which appear below position five in a vertical ad layout. Search engines, such as Google, also reward highly relevant ads with a position bonus. That is, ads with higher clickthrough rates will be shown higher in the search results. Ads with low clickthrough rates will appear lower in the search results, or advertisers will be forced to pay higher prices to compensate for the position penalty applied to their ads. Thus, the present system concludes that ads that appear higher in the search results have higher relative clickthrough rates.

The third filter used by the present system is to eliminate ads which have not run some minimum threshold period of time (block 310). For example, the system may eliminate ads that have not appeared for at least four weeks. Through the process of split testing, effective ads tend to become “controls.” These ads tend to outperform other variants in subsequent tests. Thus, by lengthening the duration of a testing period, the present system can further eliminate less effective ads which have not had a chance to prove themselves.

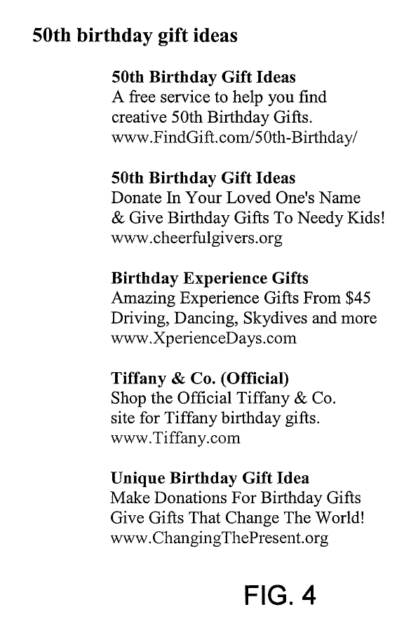

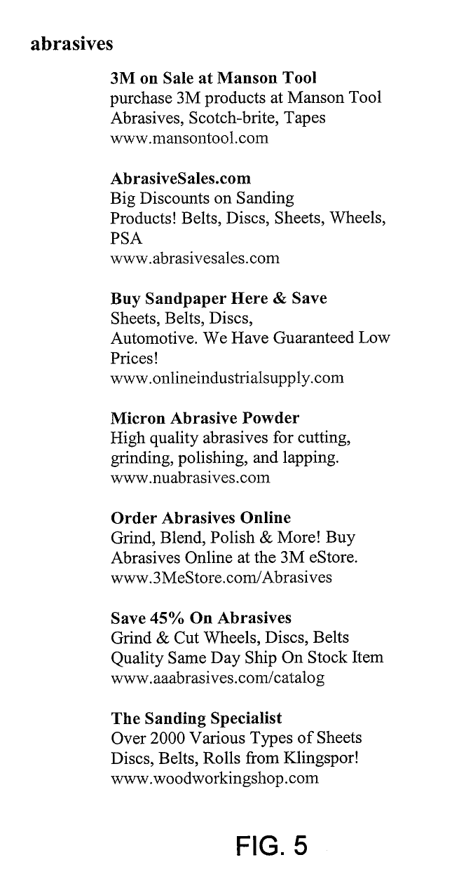

By applying these three filters to the historical database of ad copy, the present system is able to eliminate all but a small percentage (e.g., 5%) of ads, each of which has a strong probability of having a high clickthrough rate. An example of effective ad copy that remains after these three filters are applied to a plurality of ads is illustrated in FIG. 4. In this example, the keywords are “50^{th} birthday gift ideas.” FIG. 5 is another example of effective ad copy that remains after a plurality of ads are filtered. In this example, the only keyword is “abrasives.”

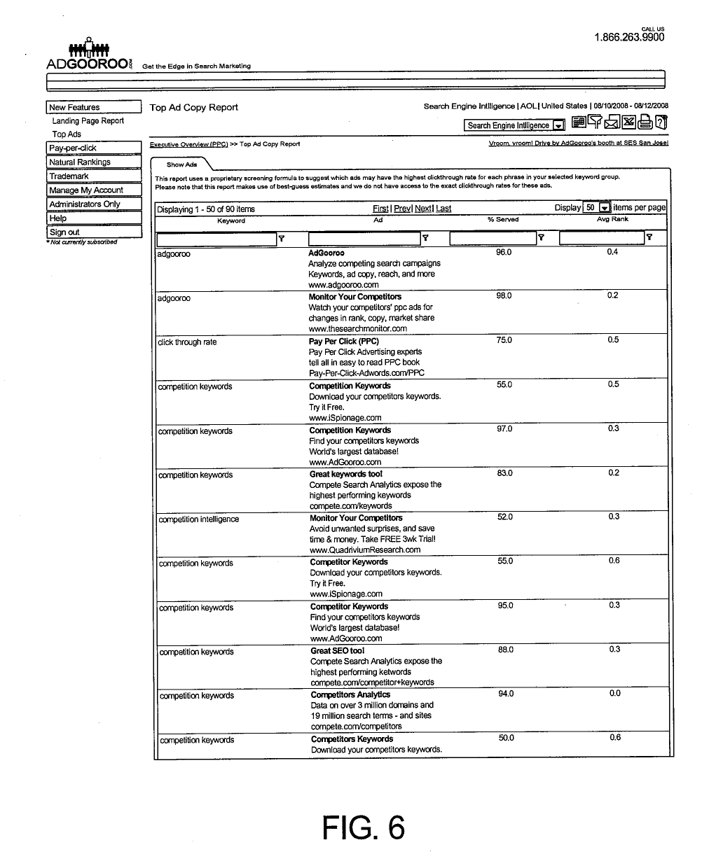

FIG. 6 shows an example report that search advertisers can use to obtain examples of the industry's most effective search advertisements, including those of competitors. The report may be provided as a web page via the Internet. This reporting function selects ads positioned to perform exceptionally well. Search advertisers can mine their keywords for the most effective ad copy in any industry. The example report compares the effectiveness of online ads served in response to specific keyword searches, determining relevance based on various factors including coverage (percentage of time an ad appears for a given keyword), position (relative high or low position on the search results page), and runtime (the number of days an ad has been run). Armed with this analysis of advertising effectiveness, advertisers can employ copywriting techniques that have proven successful in generating attention and response for specific sets of keywords.

In summary, persons of ordinary skill in the art will readily appreciate that methods and apparatus for determining advertisement relevance have been provided. The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description of examples, but rather by the claims appended hereto.

What is claimed is:

1. A method of determining advertisement relevance, the method comprising:
storing a plurality of advertisements;
receiving at least one keyword;
filtering the plurality of advertisements based on the at least one keyword, a coverage associated with each of the plurality of advertisements, a screen position associated with each of the plurality of advertisements, and a run duration associated with each of the plurality of advertisements to produce a subset of advertisements;
generating a report including at least one advertisement from the subset of advertisements; and
transmitting the report to a client device for display.

2. The method of claim 1, wherein storing the plurality of advertisements includes storing the plurality of advertisements in a database.

3. The method of claim 1, wherein receiving the at least one keyword includes receiving the at least one keyword via the Internet.

4. The method of claim 1, wherein filtering the plurality of advertisements based on the coverage associated with each of the plurality of advertisements includes eliminating advertisements from inclusion in the subset of advertisements that have a coverage of less than 50%.

5. The method of claim 1, wherein filtering the plurality of advertisements based on the screen position associated with each of the plurality of advertisements includes eliminating advertisements from inclusion in the subset of advertisements that have a screen position that is more than half way down a vertical layout.

6. The method of claim 1, wherein filtering the plurality of advertisements based on the run duration associated with each of the plurality of advertisements includes eliminating advertisements from inclusion in the subset of advertisements that have a run duration that is less than thirty days.

7. The method of claim 1, wherein the report includes the at least one keyword.

8. The method of claim 1, wherein transmitting the report to the client device for display includes transmitting a web page via the Internet.

9. The method of claim 1, wherein transmitting the report to the client device for display includes transmitting a response to an application programming interface query.

10. An apparatus for determining advertisement relevance, the apparatus comprising:
a processor;
an input device operatively coupled to the processor;
an output device operatively coupled to the processor; and
a memory device operatively coupled to the processor, the memory device storing instructions to cause the processor to:
receive at least one keyword via the input device;
filter a plurality of advertisements based on the at least one keyword, a coverage associated with each of the plurality of advertisements, a screen position associated with each of the plurality of advertisements, and a run duration associated with each of the plurality of advertisements to produce a subset of advertisements;
generate a report including at least one advertisement from the subset of advertisements; and
transmit the report via the output device.

11. The apparatus of claim 10, wherein the input device receives the at least one keyword via the Internet.

12. The apparatus of claim 10, wherein the processor eliminates advertisements from inclusion in the subset of advertisements that have a coverage of less than 50%.

13. The apparatus of claim 10, wherein the processor eliminates advertisements from inclusion in the subset of advertisements that have a screen position that is more than half way down a vertical layout.

14. The apparatus of claim 10, wherein the processor eliminates advertisements from inclusion in the subset of advertisements that have a run duration that is less than thirty days.

15. The apparatus of claim 10, wherein the report includes the at least one keyword.

16. The apparatus of claim 10, wherein the output device transmits the report as a web page to a client device.

17. The apparatus of claim 10, wherein the output device transmits the report as a response to an application programming interface query.

18. A computer readable memory device storing instructions to cause a computing device to:
receive at least one keyword;
filter a plurality of advertisements based on the at least one keyword, a coverage associated with each of the plurality of advertisements, a screen position associated with each of the plurality of advertisements, and a run duration associated with each of the plurality of advertisements to produce a subset of advertisements;
generate a report including at least one advertisement from the subset of advertisements; and
transmit the report.

19. The computer readable memory device of claim 18, wherein the instructions cause the computing device to receive the at least one keyword via the Internet.

20. The computer readable memory device of claim 18, wherein the instructions cause the computing device to eliminate advertisements from inclusion in the subset of advertisements that have a coverage of less than 50%.

21. The computer readable memory device of claim 18, wherein the instructions cause the computing device to eliminate advertisements from inclusion in the subset of advertisements that have a screen position that is more than half way down a vertical layout.

22. The computer readable memory device of claim 18, wherein the instructions cause the computing device to eliminate advertisements from inclusion in the subset of advertisements that have a run duration that is less than thirty days.

23. The computer readable memory device of claim 18, wherein the instructions cause the computing device to include the at least one keyword in the report.

24. The computer readable memory device of claim 18, wherein the instructions cause the computing device to transmit the report as a web page to a client device.

25. The computer readable memory device of claim 18, wherein the instructions cause the computing device to transmit the report as a response to an application programming interface query.
